(19) United States
(12) Patent Application Publication
(10) Pub. No.: US 2018/0107266 A1
(43) Pub. Date: Apr. 19, 2018

(54) MOTION-SENSING CONTROL DEVICE

(71) Applicant: META TECHNOLOGIES INC., Irvine, CA (US)

(72) Inventor: Weixun MA, Zheji-ang (CN)

(73) Assignee: META TECHNOLOGIES INC., Irvine, CA (US)

(21) Appl. No.: 15/567,222

(22) PCT Filed: Apr. 18, 2016
(86) PCT No.: PCT/CN2016/079534

§ 371 Date: Oct. 17, 2017

(30) Foreign Application Priority Data
Apr. 17, 2015 (CN) 201510183226.4

(51) Int. Cl. G06F 3/01

(52) U.S. Cl. CPC G06F 3/011; G06F 3/016

(57) ABSTRACT

Provided is a somatosensory control device (100), comprising a power supply module (10), a posture sensing module (11) and a transmission module (12). The power supply module (10) is electrically connected to the posture sensing module (11) and the transmission module (12), respectively, to supply power thereto. The posture sensing module (11) is configured to sense a motion state and convert the motion state into posture data. The transmission module (12) is configured to receive and externally transmit the posture data outputted by the posture sensing module (11). The posture sensing module (11) comprises a posture sensor (111) and a posture data processor (112). The posture data processor (112) is configured to process posture information sensed by the posture sensor (111) and convert the posture information into posture data. The transmission module (12) comprises a data transmission unit (121) and a transmission control unit (122). The transmission control unit (122) is configured to control the data transmission unit (121) to receive and transmit the posture data.

### TECHNICAL FIELD

The present disclosure relates to a somatosensory control device, and more particularly, to a somatosensory control device capable of enhancing human-computer interaction.

### BACKGROUND

Human-computer interaction technology, such as somatosensory games, is being favored by people for its functions of fitness and entertainment. At present, the human-computer interaction technology is usually achieved by a somatosensory control device connected to a television set, a set-top box or the like, such as a camera or a game pad. In this case, humans can only interact with the television set in a very limited range, which limits the scope of people's activities and the somatosensory interaction. Moreover, it is difficult for the somatosensory control device of the prior art to recognize complex motion because its capability to process motion information of humans and other objects is not sufficient, therefore people's sense of reality is affected.

### SUMMARY

In view of the above, it is necessary to provide a somatosensory control device capable of enhancing sense of reality of humans during human-computer interaction.

A somatosensory control device comprises a power supply module, a posture sensing module and a transmission module. The power supply module is electrically connected to the posture sensing module and the transmission module to supply power thereto. The posture sensing module is configured to sense a motion state and convert the motion state into posture data. The transmission module is configured to receive and externally transmit the posture data outputted by the posture sensing module. The posture sensing module comprises a posture sensor and a posture data processor. The posture data processor is configured to process posture information sensed by the posture sensor and convert the posture information into posture data. The transmission module comprises a data transmission unit and a transmission control unit. The transmission control unit is configured to control the data transmission unit to receive and transmit the posture data.

Compared with the existing somatosensory control devices, the somatosensory control device of the present disclosure is provided with the posture data processor dedicated to processing motion data sensed by the posture sensor, thus data processing capability is greatly enhanced, more data can be processed in a short time, and delays of the data processing are reduced, therefore, the sensitivity of the somatosensory control device and the sense of reality of humans during interaction are enhanced.

### BRIEF DESCRIPTION OF DRAWINGS

FIG. 1 shows a schematic view of the somatosensory control device according to an embodiment of the present disclosure.

### SYMBOL DESCRIPTION

TABLE 1

| | |
|---|---|
| somatosensory control device | 100 |
| power supply module | 10 |
| posture sensing module | 11 |
| transmission module | 12 |
| vibrator | 13 |
| light emitting unit | 14 |
| communication unit | 15 |
| battery unit | 101 |
| charging circuit | 102 |
| power management unit | 103 |
| posture sensor | 111 |
| posture data processor | 112 |
| data transmission unit | 121 |
| transmission control unit | 122 |
| data storage unit | 123 |

The present disclosure will be further illustrated by the following detailed description with the accompanying drawings.

### DETAILED DESCRIPTION OF DISCLOSED EMBODIMENTS

The somatosensory control device of the present disclosure will be described in further detail below with reference to the accompanying drawings and specific examples.

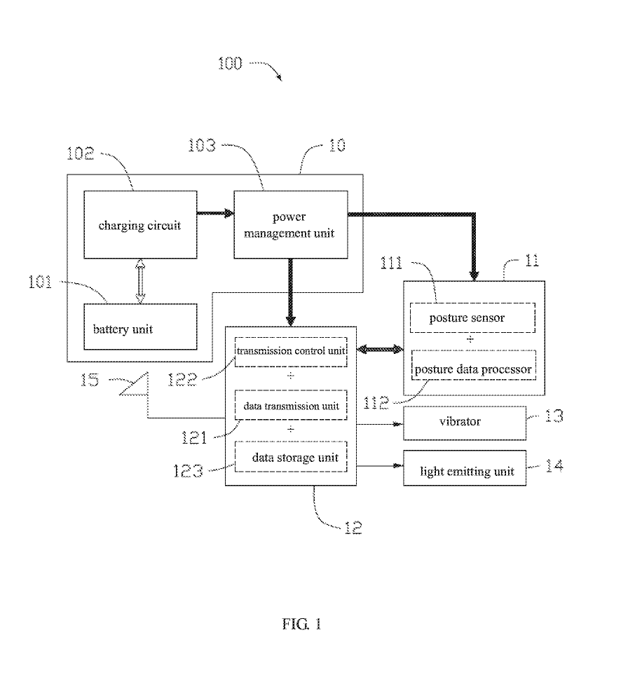

Referring to FIG. 1, one embodiment of the preset disclosure provides a somatosensory control device 100, comprising a power supply module 10, a posture sensing module 11 and a transmission module 12.

The power supply module 10 is connected to the posture sensing module 11 and the transmission module 12 to supply power thereto. The power supply module 10 comprises a battery unit 101, a charging circuit 102 and a power management unit 103. The battery unit 101 is electrically connected to the power management unit 103 via the charging circuit 102, and is configured to supply power to the posture sensing module 11 and the transmission module 12 via the power management unit 103, respectively. Specifically, the battery unit 101 can be a rechargeable button battery with charging characteristics or a button battery without charging characteristics. Alternatively, the battery unit 101 can be a lithium-ion battery or an alkaline battery with or without charging characteristics. In one embodiment, the battery unit 101 is a rechargeable lithium-ion battery with a capacity of 130 mAh. The power management unit 103 may have multiple power consumption modes, in order to control the battery unit 101 to switch between different power consumption modes, thereby effectively prolonging usage time of the battery unit 101.

The posture sensing module 11 comprises a posture sensor 111 and a posture data processor (i.e. a MCU) 112 packaged in a same chip (IC), and the posture sensing module 11 is connected to the power module 10. The posture sensor 111 can be a nine-axis sensor comprising a three-axis acceleration sensor, a three-axis gyro sensor and a three-axis geomagnetic sensor. The posture sensor 111 is configured to monitor various motion states of humans and other objects, and input the motion information monitored into the posture data processor 112. Specifically, the three-axis acceleration sensor is configured to generate gravitational acceleration sensing signals and collect and transmit acceleration information to the posture data processor 112 for processing; the three-axis gyro sensor is an angular motion sensing device which can sense and convert changes of angular velocity into electrical signals, collect and transmit information of angular velocity to the posture data processor 112 for processing; the three-axis geomagnetic sensor is configured to collect and transmit information of direction, i.e. information of magnetic field vectors, to the posture data processor 112 for processing. Furthermore, a sensing time of the posture sensor 111 to sense the generating motion state is less than 20 ms, i.e. the rate of processing the posture information by the posture sensing module 11 is 50 groups per second, thus delays are effectively reduced, and large quantity of data can be transmitted in an extremely short time.

The posture data processor 112 is configured to perform primary integration and conversion on the posture data collected by the posture sensor 111 so as to convert the posture data into absolute acceleration, angular velocity and direction and other data relative to ground surface, and to transmit these data to the transmission module 12. Specifically, the posture data processor 112 is configured to integrate, analyze and convert large quantity of data collected by the posture sensor 111 into standardized values suitable for different application programs or games.

The transmission module 12 comprises a data transmission unit 121 and a transmission control unit 122. Further, the data transmission unit 121 and the transmission control unit 122 are packaged in a same chip. The data transmission unit 121 is configured to receive posture data outputted by the posture sensing module 11 and transmit the posture data to other external electronic devices in order to control the electronic devices via the somatosensory control device 100. The transmission control unit 122 is connected to the data transmission unit 121 to control data transmission of the data transmission unit 121. The data transmission unit 121 can be a wireless unit, an infrared unit or a Bluetooth unit. In this embodiment, the data transmission unit 121 is a low-energy Bluetooth (BLE) unit, and is compatible to BT technological standards, thus it can adapt to be connected to different electronic devices to realize data transmission.

Furthermore, the transmission module 12 comprises a data storage unit 123 connected to the data transmission unit 121 and the transmission control unit 122. The data storage unit 123 is configured to store data transmitted from the posture sensing module 11 and transmit the data to the data transmission unit 121 under control of the transmission control unit 122 according to different instructions. In this embodiment, the data storage unit 123 is a flash RAM.

Furthermore, the somatosensory control device 100 comprises a vibrator 13 configured to receive signals and generate vibration. The vibrator 13 can generate vibration upon receiving certain signals analyzed by the posture sensing module 11, thereby performing the function of alerting and the like, and enhancing sense of reality of humans during human-computer interaction.

Furthermore, the somatosensory control device 100 comprises a light emitting unit 14, the light emitting unit 14 is electrically connected to the posture sensing module 11 and the transmission module 12, respectively, and can emit light, blink and indicate electricity under control of the posture data processor 112 and the transmission control unit 122. In this embodiment, the light emitting unit 14 is a color-changing LED lamp.

Furthermore, the somatosensory control device 100 can comprise a communication unit 15, the communication unit 15 is connected to the data transmission unit 121 to externally transmit data in order to more effectively transmit data to other electronic devices to achieve interaction between the somatosensory control device 100 and other electronic devices. In this embodiment, the communication unit 15 is a Bluetooth antenna.

According to the present disclosure, the somatosensory control device has following advantages. Firstly, the posture data processor is dedicated to processing motion data sensed by the posture sensor, data process ability is greatly enhanced, more data can be processed in a short time and data processing delays are reduced, thus the sensitivity of the somatosensory control device of the present disclosure and sense of reality of humans during interaction are enhanced; secondly, the data transmission module and the transmission control unit are dedicated for data transmission, time delays during data transmission can be reduced, and more data can be transmitted to other electronic elements in a short time, thus the sense of reality of humans during interaction is further enhanced; lastly, by packaging the data transmission module, the transmission control unit and the storage module in a same chip, the whole power consumption is greatly reduced, thus the useful life of the somatosensory control device is prolonged.

Finally, it is to be understood that those skilled in the art may make variations to the embodiment within the spirit of the present disclosure, and such variations that follow the spirit of the disclosure are intended to be included within the scope of the disclosure as claimed.

What is claimed is:

1. A somatosensory control device, comprising a power supply module, a posture sensing module and a transmission module;
wherein the power supply module is electrically connected to the posture sensing module and the transmission module, respectively, to supply power thereto;
the posture sensing module is configured to sense a motion state and convert the motion state into posture data; and
the transmission module is configured to receive and externally transmit the posture data outputted by the posture sensing module;
wherein the posture sensing module comprises a posture sensor and a posture data processor, the posture data processor is configured to process posture information sensed by the posture sensor and convert the posture information into posture data, the transmission module comprises a data transmission unit and a transmission control unit, the transmission control unit is configured to control the data transmission unit to receive and transmit the posture data.

2. The somatosensory control device of claim 1, wherein the posture sensor and the posture data processor are packaged in a same chip, and the posture data processor integrates and converts the posture information collected by the posture sensor into a standardized value.

3. The somatosensory control device of claim 2, wherein the rate of processing the posture information by the posture sensing module processes is greater than 50 groups per second.

4. The somatosensory control device of claim 1, wherein the data transmission unit and the transmission control unit are packaged in a same chip.

5. The somatosensory control device of claim 1, wherein the posture sensor is a nine-axis sense, comprising a three-axis acceleration sensor, a three-axis gyro sensor and a three-axis geomagnetic sensor.

6. The somatosensory control device of claim 1, wherein the data transmission unit is a low-energy Bluetooth unit.

7. The somatosensory control device of claim 1, further comprising a data storage unit configured to store the posture data, the data storage unit is connected to the data transmission unit and the transmission control unit; wherein the data storage unit, the data transmission unit and the transmission control unit are packaged in a same chip.

8. The somatosensory control device of claim 1, wherein the power supply module comprises a battery unit, a charging circuit, and a power management unit electrically connected to each other.

9. The somatosensory control device of claim 7, wherein the battery unit is a lithium-ion battery with a capacity of greater than 130 mAh.

10. The somatosensory control device of claim 1, wherein the somatosensory control device further comprises a vibrator, a light emitting unit, and a communication unit; wherein the vibrator is configured to receive signals and generate vibration; the light emitting unit is configured to receive signals and emit light; and the communication unit is connected to the data transmission unit and is configured to externally transmit data.
